(19) United States
(12) Patent Application Publication
(10) Pub. No.: US 2021/0381261 A1
(43) Pub. Date: Dec. 9, 2021

(54) LOCK MECHANISM FOR A SCAFFOLDING CLAMP

(71) Applicant: SCAFFSHIELD PTY LTD, Somersby NSW (AU)

(72) Inventor: Jason SABA, South Coogee NSW (AU)

(21) Appl. No.: 17/088,709

(22) Filed: Nov. 4, 2020

(30) Foreign Application Priority Data
Sep. 5, 2019 (AU) 2019903279

(51) Int. Cl. E04G 7/14; F16B 7/04

(52) U.S. Cl. CPC E04G 7/14; F16B 7/0493

(57) ABSTRACT

A lock mechanism (10) for a scaffolding clamp or coupler (33) having a threaded rod (15) and a securing nut (14) is disclosed. The mechanism deters unauthorised removal of the securing nut and has a locknut (12) engageable with the threaded rod and having an unconventional drive mechanism (17). The mechanism also has a substantially cylindrical hollow sleeve (13) with a cylindrical interior dimensioned to surround the securing nut and locknut. The locknut has a main body with a tapered nose (21) able to bear against the securing nut and an annular recess (23). The sleeve interior has an inwardly projecting substantially annular flange (26) through which the nose can be forced to locate the flange in the recess and thereby retain the sleeve on the locknut. In addition, the sleeve has an exterior which is smooth and devoid of projections and recesses, and an axial length greater than the combined axial lengths of said securing nut and locknut, to thereby shield both the securing nut and the lock nut. A cup shaped shield (40) and cap (45) for masonry bolts (37) is also disclosed.

### CROSS REFERENCE TO RELATED APPLICATIONS

This application claims priority to Application No. 2019903279 filed in Australia on Sep. 5, 2019, the entire contents of which is hereby incorporated by reference.

### Field of the Invention

The present invention relates to scaffolding.

### Background Art

Scaffolding is used during the construction, or repair, of buildings to provide an exterior work platform upon which tradesmen can be supported whilst working on the exterior of the building and, in particular, the exterior of the upper floors of the building.

In order to provide structural integrity, ties which project from the building are connected to the scaffolding structure by means of scaffolding clamps (also called couplers). Such scaffolding clamps or couplers comprise two portions which are hinged together and which are able to be clamped to a length of pipe or other member of a scaffolding frame. The scaffolding clamps include a threaded rod which passes through an aperture and is secured by means of a securing nut.

When the building, or its repair, is nearing completion, the scaffolding is dismantled in progressive stages commencing from the top of the scaffold. This enables each layer of the scaffolding to the dismantled in turn. As each layer is dismantled, so the uppermost layer of the scaffolding is disconnected from the building ties by undoing the corresponding scaffolding clamps. This enables the ties from that layer to be removed from the building and the exterior of the building opposite the uppermost layer of the scaffolding finished off. Then the next layer of scaffolding with its building ties, is removed, and so on. In this way the scaffolding being dismantled is always in a safe condition.

Unfortunately, many tradesmen adopt the unsafe practice of prematurely removing scaffold clamps and/or ties so as to complete their finishing activities in advance of the intended dismantling of the scaffold. This is done in order to reduce the likelihood of a return trip to the building site at a later date. This activity is normally undertaken by employees or subcontractors without the knowledge or approval of the master builder and has the effect of placing the scaffolding into a dangerous condition. It is not unknown for scaffolding in this condition to collapse leading, in some instances, to loss of life.

### Genesis of the Invention

The Genesis of the present invention is a desire to prevent, or at least deter, this unauthorised removal of, or loosening of, scaffolding clamps and/or ties and thereby prevent scaffolding being moved into a dangerous condition.

Following the conception of the present invention, prior art searches have been conducted and such searches disclosed UK Patent Application No 2, 239, 482 in the name of Aberdeen Scaffolding Company Ltd. The specification of this application discloses a lock mechanism for a scaffolding clamp having a threaded rod and a securing nut. The lock mechanism takes the form of a locknut and a sleeve. The locknut has a drive mechanism in the form of a recess with four interior lobes able to be driven by a driver with a corresponding projection with four exterior lobes. The locknut has an exterior circumferential groove into which a grub screw mounted on the sleeve projects in order to retain the sleeve on the locknut.

This mechanism suffers from a defect. If the grub screw is tightened to a maximum extent such that its tip is frictionally engaged with the base of the circumferential groove, then a Stillson wrench or pipe wrench applied to the sleeve may well be capable of rotating the sleeve and the locknut, thereby undoing the scaffolding clamp.

### SUMMARY OF THE INVENTION

In accordance with a first aspect of the present invention there is disclosed a lock mechanism for a scaffolding clamp having a threaded rod and a securing nut, said mechanism deterring unauthorised removal of the securing nut,

said mechanism comprising a locknut engageable with said threaded rod and having an unconventional drive mechanism, and a substantially cylindrical hollow sleeve having a cylindrical interior dimensioned to surround said securing nut and locknut, wherein

said locknut has a main body with a tapered nose able to bear against said securing nut and an annular recess,

said sleeve interior has an inwardly projecting substantially annular flange through which said nose can be forced to locate said flange in said recess and thereby retain said sleeve on said locknut,

said sleeve has an exterior which is smooth and devoid of projections and recesses, and

said sleeve has an axial length greater than the combined axial lengths of said securing nut and locknut, to thereby shield both said securing nut and said lock nut

In accordance with a second aspect of the present invention the scaffolding clamp is attached to pipework which is in turn connected to ties which are bolted to a building using at least one masonry bolt, and a cup shaped shield is provided for the head of said masonry bolt.

According to another aspect of the present invention there is provided a method of securing a scaffold and scaffold ties.

In accordance with a still further aspect of the present invention there is disclosed a security shield and cap for a masonry bolt or anchor, said shield comprising a hollow cylinder being closed at one end and open at the other end, said closed end having an aperture therein for receiving a shank of said bolt or anchor, the exterior of said shield having an annular groove therein, and said cap being dimensioned to be slidingly engaged with said hollow cylinder and having an internal annular ridge engageable with said annular groove to assist in retaining said cap on said shield.

### BRIEF DESCRIPTION OF THE DRAWINGS

Some embodiments of the invention will now be described, by way of example only, with reference to the accompanying drawings in which:

FIG. 1 is an exploded perspective view of the lock mechanism of the preferred embodiment,

FIG. 2 is a side elevation showing the stages involved in securing the securing nut,

FIG. 3 is a side elevation of the securing nut in the secured condition,

FIG. 4 is a perspective view of a portion of a scaffold showing securing nuts in the secured condition

FIG. 5 is an exploded vertical cross-sectional view of a shield useful in relation to masonry bolts,

FIG. 6 is an equivalent view to that of FIG. 5 but showing the arrangement in an assembled condition, and

FIG. 7 is an exploded vertical cross-sectional view of a shield of FIGS. 5 and 6 but used in relation to masonry anchors,

FIG. 8 is a perspective view of a cap that may be placed over the shield of FIG.

7,

FIG. 9 is a perspective view of a pipe spanner and its driving tool for driving the masonry bolt of FIG. 5, and

FIG. 10 is a perspective view of the shield of FIGS. 5 and 6.

### DETAILED DESCRIPTION

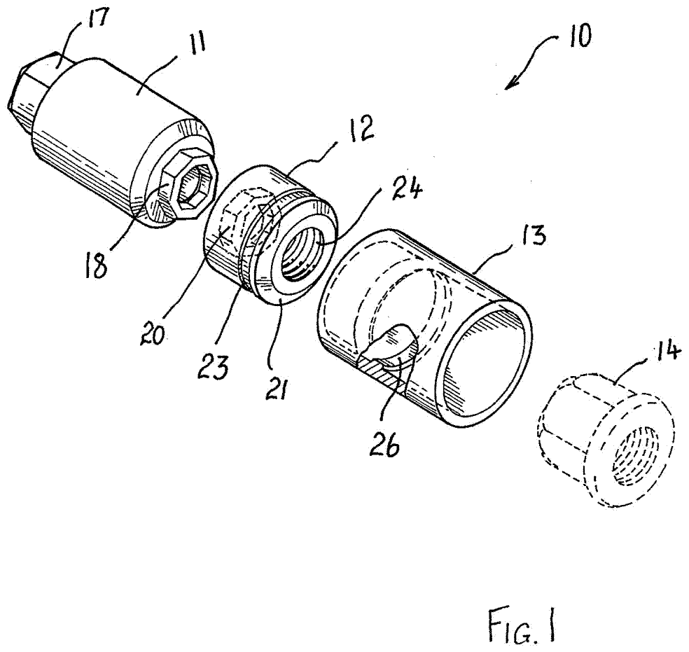

As seen in FIG. 1, the locking mechanism 10 of the preferred embodiment consists of a driver 11, a locknut 12, and a sleeve 13. The locking mechanism 10 is intended to secure a securing nut 14 which is threadably engaged with a threaded rod 15 (FIG. 2).

The driver 11 has a conventional hexagonal boss 17 at one end which enables the driver 11 to be rotated by a conventional spanner (not illustrated). At the other end the driver 11 has an unconventional eight faced boss 18 which is dimensioned to engage with, and drive, an eight faced recess 20 in the locknut 12.

The locknut 12 has a tapered but flat nose 21, an annular recess 23 and an internal thread 24 which is dimensioned to mate with the threaded rod 15. The locknut 12 is hollow so that the threaded rod 15 can, if necessary, project through the internal thread 24 and into the eight faced recess 20.

The sleeve 13 has an entirely smooth exterior and is provided with an internal annular flange 26 which projects inwardly into the cylindrical interior of the sleeve 13. The internal diameter of the sleeve 13 is dimensioned to be just slightly larger than the external diameter of the locknut 12. As a consequence, the locknut 12 can be slid into the sleeve 13 and, with the tap of a hammer, the tapered nose 21 is able to be forced past the annular flange 26. This retains the locknut 12 within the sleeve 13 since this action is unable to be reversed.

Turning now to FIG. 2, the locknut 12 and sleeve 13 so assembled, is able to be placed above the securing nut 14 and the threaded rod 15 engaged with the internal thread 24 of the locknut 12. By engaging the driver 11 with the locknut 12, the eight faced boss 16 mates with the eight faced recess 20 and this permits the locknut 12 to be rotated within the sleeve 13. This rotation drives the tapered nose 21 of the locknut 12 into engagement with the securing nut 14. This prevents the securing nut 14 being rotated relative to the threaded rod 15.

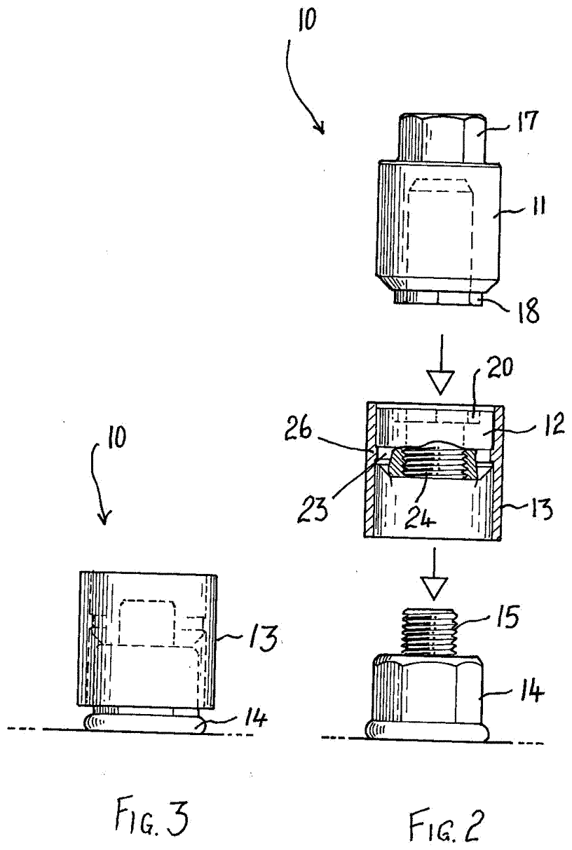

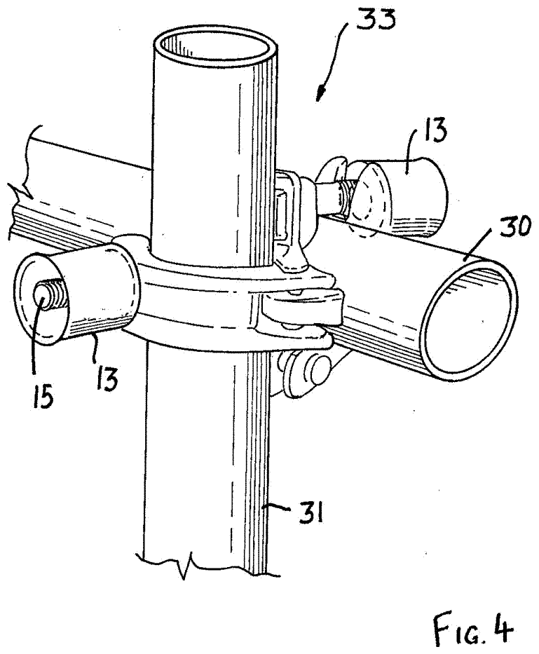

As seen in FIG. 3, the length of the sleeve 13 is sufficient to shield the securing nut 14 from conventional tools such as a spanner, a pair of pliers or a Stillson wrench. As a consequence, the securing nut 14 itself is shielded from any operative tool. In addition, any attempt to rotate the sleeve 13 simply rotates the sleeve 13 without being able to rotate the locknut 12. Since the recess 20 has an unconventional shape, this deters most tradesmen from attempting to remove the locking mechanism 10.

Turning now to FIG. 4, a horizontal pipe 30 and a vertical pipe 31 forming part of a scaffold are illustrated being secured together by means of a conventional scaffolding clamp 33. Each securing nut of the clamp 33 is illustrated being provided with a locking mechanism 10 in the state illustrated in FIG. 3.

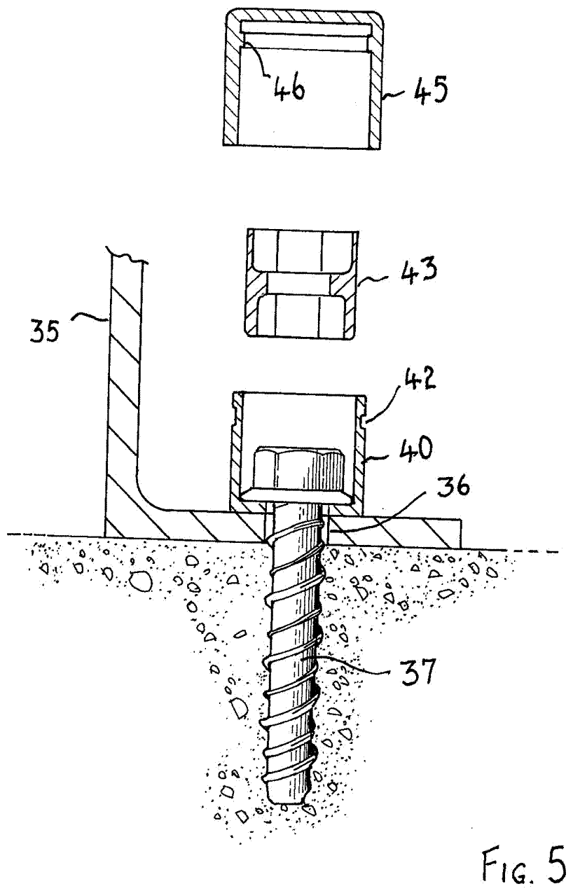

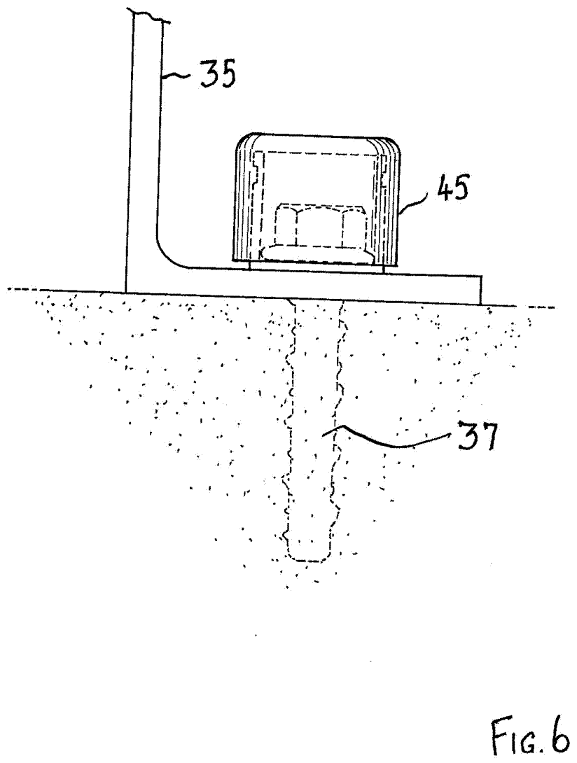

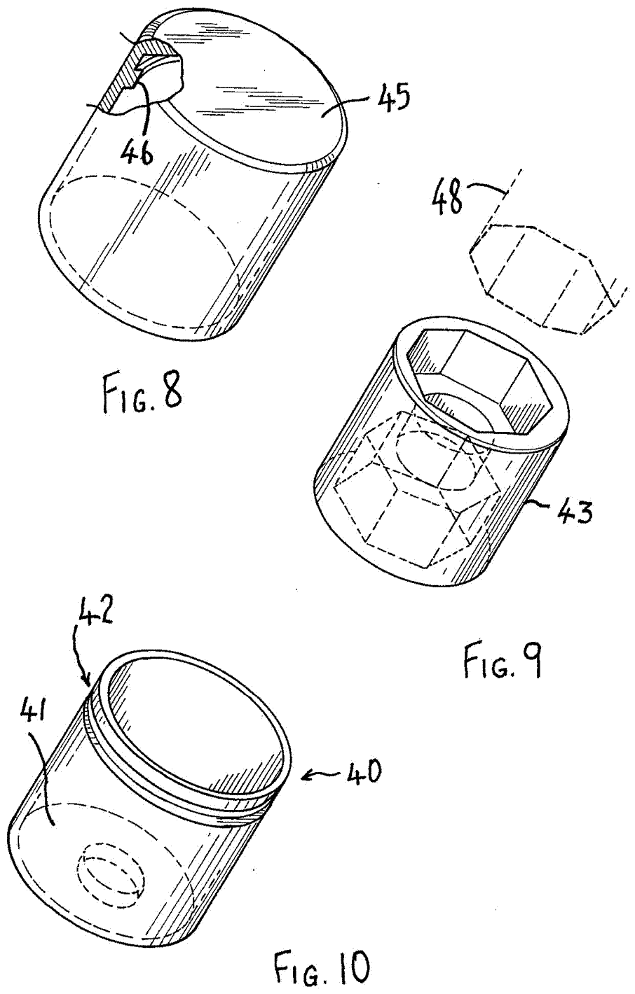

In addition to the clamps 33 securing the pipework of a scaffold, the pipework is also secured to metal ties which are bolted to the exterior walls of the building, normally using masonry bolts or masonry anchors. As seen in FIGS. 5 and 6 the metal tie 35 has a hole 36 through which the shank of a masonry bolt 37 is able to pass. Prior to securing the tie, a cup shaped shield 40 having an apertured base 41 (FIG. 10) is slipped over the shank of the masonry bolt 37 before the shank is inserted into the building wall.

The head of the masonry bolt 37 is driven by means of a thin-walled pipe or socket spanner 43 so as to secure the masonry bolt 37 into the building wall in the usual fashion. There is a narrow clearance between the shield 40 and the pipe spanner 43 which is just enough to enable the pipe spanner 43 to drive the masonry bolt 37, but is not enough to enable a conventional socket spanner to be used to engage the masonry bolt 37.

Once the masonry bolt 37 is driven home, the pipe spanner 43 is removed and a cylindrical plastic cap 45 is preferably placed over the metal shield 40. Preferably the shield 40 has an exterior annular groove 42 which mates with an internal annular ridge 46 within the interior of the plastic cap 45. The plastic cap 45 has two functions, the first is that its bright colouring (such as yellow) draws attention to the shield 40 and thereby reminds tradesmen of the importance of the security of the scaffold. The second function of the plastic cap 45 is to prevent dirt and grit getting into the narrow space between the head of the masonry bolt 37 and the shield 40. If this space becomes blocked with dirt and grit, it becomes very difficult to use the pipe spanner 43 when the scaffold is required to be dismantled. The inter-engaged shield 40 and cap 45 are illustrated in FIG. 6.

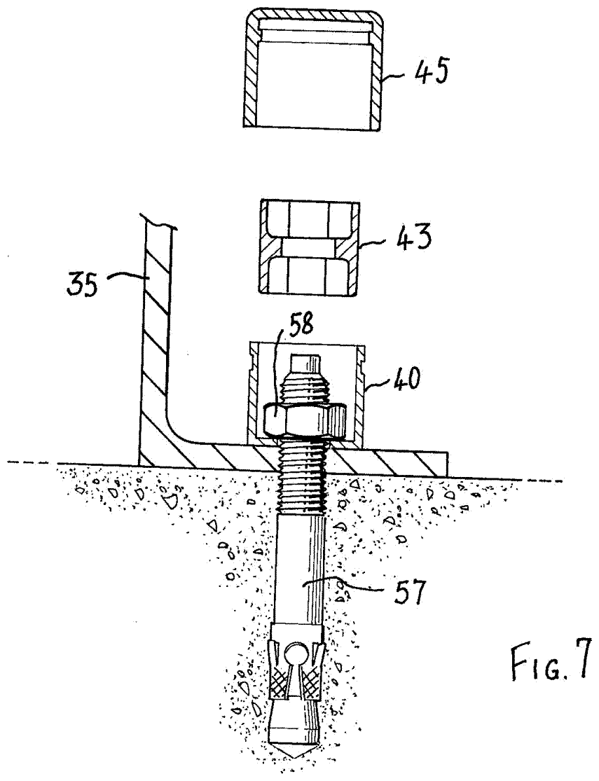

As illustrated in FIG. 7, it is also possible to apply the shield 40 and cap 45 to a masonry anchor 57 which has a securing nut 58. The cap 45 is illustrated in more detail in FIG. 8. The pipe spanner 43 and its driving tool 48 are illustrated in more detail in FIG. 9. Finally, the shield 40 is illustrated in more detail in FIG. 10.

The foregoing describes only some embodiments of the present invention and modifications, obvious to those skilled in the building and construction arts, can be made thereto without departing from the scope of the present invention. For example, the sleeve 13 can be provided with a plastic cap which covers the eight faced recess 20 and can be coloured brightly so as to draw attention to its absence following any attempt to undo the locknut/sleeve.

Furthermore, is clearly also possible to replace the conventional hexagonal nut 14 or the conventional hexagonal head of the masonry bolt 37 with an unconventional shape. The intention of this obvious strategy is to require a special tool, only available to authorised personnel, to be used to undo the scaffold clamp or coupler and/or the tie. However the problem with the strategy is that tools such as multi-wrenches and Stillson wrenches are widely available on building sites and effective to remove such nuts or bolts with an unconventional shape. Another disadvantage of this strategy is that the fasteners of unconventional shape are more expensive than fasteners of conventional shape. The provision of the sleeve 13 and/or shield 40 overcomes these difficulties.

The term “comprising” (and its grammatical variations) as used herein is used in the inclusive sense of “including” or “having” and not in the exclusive sense of “consisting only of”.

1. A lock mechanism for a scaffolding clamp having a threaded rod and a securing nut, said mechanism deterring unauthorised removal of the securing nut,
said mechanism comprising a locknut engageable with said threaded rod and having an unconventional drive mechanism, and a substantially cylindrical hollow sleeve having a cylindrical interior dimensioned to surround said securing nut and locknut, wherein
said locknut has a main body with a tapered nose able to bear against said securing nut and an annular recess,
said sleeve interior has an inwardly projecting substantially annular flange through which said nose can be forced to locate said flange in said recess and thereby retain said sleeve on said locknut,
said sleeve has an exterior which is smooth and devoid of projections and recesses, and
said sleeve has an axial length greater than the combined axial lengths of said securing nut and locknut, to thereby shield both said securing nut and said lock nut.

2. The lock mechanism as claimed in claim 1 wherein said tapered nose has a flat leading surface.

3. The lock mechanism as claimed in claim 1 wherein said unconventional drive mechanism comprises an eight faced boss and recess.

4. The lock mechanism as claimed in claim 3 wherein said eight faced recess is on said locknut and said eight faced boss is on a driver for said locknut.

5. The lock mechanism as claimed in claim 1 wherein said scaffolding clamp is attached to pipework which is in turn connected to ties which are bolted to a building using at least one masonry bolt, and a cup shaped shield is provided for the head of said masonry bolt.

6. The lock mechanism as claimed in claim 5 wherein a small clearance is provided between said shield and said masonry bolt head, and a thin walled pipe spanner is engageable with said bolt head.

7. The lock mechanism as claimed in claim 5 wherein said shield has a substantially cylindrical cover to prevent ingress of material into said small clearance.

8. A security shield and cap for a masonry bolt or anchor, said shield comprising a hollow cylinder being closed at one end and open at the other end, said closed end having an aperture therein for receiving a shank of said bolt or anchor, the exterior of said shield having an annular groove therein, and said cap being dimensioned to be slidingly engaged with said hollow cylinder and having an internal annular ridge engageable with said annular groove to assist in retaining said cap on said shield.
